(19) United States
(12) Patent Application Publication
(10) Pub. No.: US 2022/0066113 A1
(43) Pub. Date: Mar. 3, 2022

(54) GAS PRESSURE MAINTAINING AND ADJUSTING DEVICE, AND MICROSTRUCTURE OPTICAL FIBER AND PREPARATION METHOD THEREOF

(71) Applicant: NORTHEASTERN UNIVERSITY, Shenyan (CN)

(72) Inventors: Tonglei CHENG, Shenyan (CN); Junbo LOU, Shenyang (CN); Shuguang LI, Shenyang (CN); Fan ZHANG, Shenyang (CN)

(21) Appl. No.: 17/408,703

(22) Filed: Aug. 23, 2021

(30) Foreign Application Priority Data
Aug. 25, 2020 (CN) 202010863534.2

(51) Int. Cl. G02B 6/44; G02B 6/36; G02B 6/02

(52) U.S. Cl. CPC G02B 6/4427; G02B 6/02004; G02B 6/3652

(57) ABSTRACT

A gas pressure maintaining and adjusting device, a microstructure optical fiber and a preparation method of the microstructure optical fiber belong to the field of preparation of special optical fibers. In the gas maintaining and adjusting device, a communication control module is electrically connected with a main console of an optical fiber drawing tower; a signal output end of the communication control module is connected with a signal receiving end of a programmable logic controller (PLC); the PLC is provided with a gas pressure threshold display screen; the signal receiving end of the PLC is further connected with a signal output end of a pressure controller; and the PLC is further connected with an electromagnetic valve used for controlling opening and closing of a gas inlet and a gas outlet.

### CROSS REFERENCE TO RELATED APPLICATION(S)

This patent application claims the benefit and priority of Chinese Patent Application No. 202010863534.2, filed on Aug. 25, 2020, the disclosure of which is incorporated by reference herein in its entirety as part of the present application.

### TECHNICAL FIELD

The present disclosure belongs to the field of manufacturing of special optical fibers, and particularly relates to a gas pressure maintaining and adjusting device, and a microstructure optical fiber and a preparation method thereof.

### BACKGROUND ART

A microstructure optical fiber has a special pore structure. Due to its flexible structure, it has become a research object favored by experts and scholars all over the world. In order to obtain novel characteristics, a variety of microstructure optical fibers with different shapes have been designed, including quadrilateral optical fibers, hexagonal optical fibers, octagonal optical fibers, elliptical optical fibers, circular optical fibers, rhombic optical fibers, spiral optical fibers, hybrid optical fibers, etc. A microstructure optical fiber has many advantages that a traditional optical fiber does not have, such as single mode transmission, high birefringence, polarization, nonlinearity, large mode field area, controllable dispersion and low confinement loss.

A microstructure optical fiber is a kind of special fiber of which the structure can be converted periodically, and it can have unique physical properties by a flexible structure design. It belongs to an emerging research field. Although domestic researchers have taken a large amount of effort for research in both theory and preparation, preparation technologies are still lagging behind theory, and there are few reports on how to prepare microstructure optical fibers. The main reason is that during the research, a height of a built drawing tower is merely over three meters, and as a result it is difficult to draw a preform rod to a required optical fiber size at one time during preparation of the optical fiber, especially a size of a core of the optical fiber is generally below 10 μm. In addition, pores in the microstructure optical fiber are not well maintained. During a drawing process, a large number of pores collapse, and accordingly it is impossible to obtain an intact structure within a required size range. In some other technologies, in order to maintain the pores, one end of the preform rod is firstly sealed with oxyhydrogen flame before drawing. However, in a drawing process, after the other end of the preform rod is melted in a high-temperature furnace, bulges are generated at a part of the preform rod at a furnace core. Therefore, the problem about collapse of the pores in the microstructure optical fiber is still not well solved.

### SUMMARY

To overcome the shortcomings of the prior art, the present disclosure provides a gas pressure maintaining and adjusting device, and a microstructure optical fiber and a preparation method thereof through exploration from the perspective of a drawing process and preparation of the microstructure optical fiber. This method adopts a two-time drawing technology and a gas pressure maintaining and adjusting technology to prepare a microstructure optical fiber, where the two-time drawing technology adopts two drawing processes; and by gas pressure maintaining, collapse of pores inside a thin preform rod can be prevented. By adopting this method, an outer diameter and a core size of the optical fiber can both be lowered to an expected required size. In addition, this method can effectively solve the problems about collapse and disappearance of the pores inside the microstructure optical fiber, can maintain a designed internal structure of the microstructure optical fiber, and has the advantages of simple operation and adjustable pore size and internal cladding pore size of the optical fiber. A microstructure optical fiber prepared by this method can be applied to various optical devices such as filters, beam splitters and sensors.

The present disclosure adopts the following technical solution:

A gas pressure maintaining and adjusting device includes a communication control module, a Programmable Logic Control (PLC), a pressure controller, an electromagnetic valve and a gas pressure threshold display screen;

the communication control module is electrically connected with a main console of an optical fiber drawing tower; a signal output end of the communication control module is connected with the signal receiving end of the PLC; the PLC is provided with the gas pressure threshold display screen; the signal receiving end of the PLC is further connected with a signal output end of the pressure controller; and the PLC is further connected with the electromagnetic valve which is used for controlling the opening and closing of a gas inlet and a gas outlet.

The communication control module is used for receiving a communication signal instruction of the main console of the optical fiber drawing tower and transmitting the signal instruction to the PLC;

the pressure controller is used for detecting a pressure in real time and transmitting the detected pressure to the PLC; and

the PLC is used for displaying a gas pressure threshold transmitted by a communication module through the gas pressure threshold display screen, and comparing a pressure of the gas pressure threshold with the pressure detected by the pressure controller, thereby transmitting signals to control the opening and closing of the electromagnetic valve.

The main console of the optical fiber drawing tower is used for adjusting and setting four drawing parameters, including a temperature of a high-temperature furnace, a rod feeding speed, a traction speed and a gas pressure threshold, in a preparation process of a microstructure optical fiber by observing the condition of an end face of the optical fiber.

An optical fiber drawing tower includes an argon pipe, a gas pressure maintaining and adjusting device, a fixing device, a high-temperature furnace, an optical caliper, a drawing device, a pressure coating device, an ultraviolet curing device and a filament winding device, where the argon pipe communicates with argon; the gas pressure maintaining and adjusting device is arranged on the argon pipe; the fixing device is arranged on the optical drawing tower; the high-temperature furnace, the optical caliper, the drawing device, the pressure coating device, the ultraviolet curing device and the filament winding device are sequentially arranged below the fixing device; the fixing device, the high-temperature furnace, the optical caliper, the drawing device, the pressure coating device and the ultraviolet curing device are each provided with a drawing through hole; the drawing through holes are located in the same perpendicular line; and an output end of the argon pipe communicating with argon communicates with a thin preform rod through a gas connector.

According to the preparation method of a microstructure optical fiber of the present disclosure, the preform rod is prepared by a stepped stacking type binding method; the microstructure optical fiber is drawn by adopting a two-time drawing technology; in a second drawing process, a size of microstructure pores is adjusted through gas pressure control; and in addition, the microstructure optical fiber is drawn by adjusting four drawing parameters, including a temperature of a high-temperature furnace, a gas pressure threshold, a rod feeding speed and a traction speed.

The preparation method of a microstructure optical fiber of the present disclosure includes the following steps of:

step 1, preparation of a preform rod:

designing a microstructure optical fiber according to a simulation program; selecting glass tubes and glass rods according to a size and a structure of the designed microstructure optical fiber; drawing the glass tubes and the glass rods to form capillary tubes and capillary rods; preparing a preform rod by adopting a stepped stacking type binding method; and removing water vapor in the preform rod;

step 2, two-time drawing:

conducting the first drawing on the preform rod from which the water vapor is removed to obtain a thin preform rod, where the thin preform rod has an outer diameter of 3 mm to 5.5 mm;

sleeving a periphery of the thin preform rod with a limiting glass outer sleeve; conducting the second drawing; observing an end face of the thin preform rod in real time by an optical microscope in the second drawing process; when all microstructure pores of the optical fiber are found, connecting the thin preform rod with an argon pipe connected with argon and starting the gas pressure maintaining and adjusting device; setting a gas pressure threshold according to the condition, observed by the optical microscope, of the microstructure end face of the optical fiber; and controlling a size of the pores in the optical fiber; and

step 3, adjustment:

adjusting a temperature of the high-temperature furnace to 1743° C. to 1950° C., a gas pressure threshold to 1 kPa to 10 kPa, a rod feeding speed to 0.93 mm/min to 5 mm/min, and a traction speed to 0.5 m/min to 7.7 m/min; eliminating a gap between the thin preform rod and the limiting glass outer sleeve; observing an end face of the microstructure optical fiber in real time by an optical microscope; repeatedly adjusting drawing parameters according to the condition of the end face; simultaneously controlling a gas pressure in the pores by the gas pressure maintaining and adjusting device, so as to control and lower an outer diameter and a fiber core size of the microstructure optical fiber to finally obtain a microstructure optical fiber with an intact structure.

In the step 1, a center fiber core and a plurality of cladding layers are arranged according to the number of fiber cores and the number and structure of the cladding layers in the microstructure optical fiber, where the first cladding layer is as long as the center fiber core, the second cladding layer is 1 cm to 2 cm shorter than the first cladding layer, and the length of each of the other cladding layers is determined in this manner until the overall fiber cores and the cladding layers are formed to form a hexagonal structure; the hexagonal structure is sleeved with a glass sleeve; a space between the hexagonal structure and the glass sleeve is filled with a solid thin capillary rod to form a preform rod, where the center fiber core adopts a capillary rod or a capillary tube; capillary tubes or capillary tubes and capillary rods are used as the cladding layers according to the number and arrangement of the fiber cores of the microstructure optical fiber.

Further, in every two adjacent layers, there are 6 more capillary tubes in the outer layer than in the inner layer.

Further, a total number of used capillary tubes and capillary rods is m=3n (n+1)+1, where m is the total number of the used capillary tubes and capillary rods, and n is the number of the cladding layers arranged in the preform rod.

Further, in the step 1, each capillary rod has a diameter of 0.8 cm to 2.2 cm, the capillary tubes have the same diameter as the capillary rods, and each capillary tube has an inner diameter of 0.3 mm to 1.8 mm.

In the step 1, inner and outer walls of the selected glass tubes and glass rods need to be cleaned and dried before use; the glass tubes and the glass rods are drawn to form capillary tubes and capillary rods according to a required size of the microstructure optical fiber; and a preform rod is prepared by a stepped stacking type binding method.

In the step 1, one end of the preform rod is welded with a glass tube with a length of 200 mm to 300 mm as a tail handle; the preform rod is placed in a temperature control cabinet at 100° C. to 200° C. to remove water vapor in the preform rod; the tail handle has the same outer diameter as the glass sleeve of the preform rod, and has an inner diameter larger than or equal to the inner diameter of the glass sleeve of the preform rod.

In the step 2, the to-be-drawn optical fiber is fixed to the optical fiber drawing tower by the fixing device, and is drawn by sequentially passing through the high-temperature furnace, the optical caliper, the drawing device, the pressure coating device and the ultraviolet curing device.

In the step 2, the first drawing is conducted by adjusting the three drawing parameters, namely a temperature of the high-temperature furnace is adjusted to 1770° C. to 1950° C., a rod feeding speed is adjusted to 1 mm/min to 5 mm/min, and a traction speed is adjusted to 0.5 m/min to 7 m/min.

In the step 3, the temperature of the high-temperature furnace is adjusted in a way of being decreased first and then increased; the traction speed is adjusted in a way of being decreased and then increased; the rod feeding speed is adjusted in a way of being increased first and then decreased; and the gas pressure threshold is adjusted in a way of being increased first and then decreased.

According to the microstructure optical fiber prepared by the above preparation method, the pores of the cladding layers are arranged in a hexagonal shape as a whole, quartz is used as a base material, and the fiber cores have a diameter of 3 μm to 10 μm.

The microstructure optical fiber has an outer diameter of 120 μm to 190 μm.

In the microstructure optical fiber, the fiber cores adopt a total internal reflection type transmission mode, and the microstructure optical fiber may be one of a single-core microstructure optical fiber, a partial double-core microstructure optical fiber, a double-core microstructure optical fiber, a three-core microstructure optical fiber and a seven-core microstructure optical fiber.

Compared with an existing optical fiber preparation technology, the gas pressure maintaining and adjusting device, the microstructure optical fiber and the preparation method of the microstructure optical fiber provided by the present disclosure have the following advantages:

(1) The optical fiber preform rod is prepared by a stepped stacking type binding method, which is more convenient to operate and achieves a firmer hexagonal microstructure.

(2) A plurality of solid capillary rods are arranged to form a preform rod to prepare a multi-core microstructure optical fiber, and the method provided by the present disclosure can be used to prepare a multi-core microstructure optical fiber, such as a partial double-core microstructure optical fiber, a double-core microstructure optical fiber, a three-core microstructure optical fiber, or a seven-core microstructure optical fiber.

(3) A two-time drawing technology is adopted, where the optical fiber preform rod with an outer diameter of 20 mm is drawn into a thin preform rod with an outer diameter of 3 mm to 5.5 mm through the first drawing, and the thin preform rod has a firmer structure. The second drawing is conducted after the thin preform rod is additionally provided with the limiting glass outer sleeve, which not only lowers the outer diameter of the optical fiber to a standard size (such as 125 μm), but also lowers the core size below 10 μm.

(4) An inflation gas pipe is connected with the thin preform rod through a connector with a metal spring leaf, which solves the problem that the connector is melted by a hot gas flow.

(5) Argon is injected into the thin preform rod through the gas pressure maintaining and adjusting device, and the gas pressure threshold is adjusted in combination with the two-time drawing technology of the microstructure optical fiber, which effectively solves the problems about collapse and disappearance of the pores in the microstructure optical fiber, and also eliminates a gap between the thin preform rod and the limiting glass outer sleeve.

(6) The present disclosure achieves stable pressure maintaining by utilizing the gas pressure maintaining and adjusting device, and provides guarantee for batched preparation of microstructure optical fibers. In addition, the method of the present disclosure not only can maintain an internal structure of a microstructure optical fiber, but also can lower both the outer diameter and the core size of the optical fiber to an expected required size, and has the advantages of simple operation, adjustable size of the fiber cores, adjustable size of the pores of the internal cladding layers of the optical fibers, etc.

### BRIEF DESCRIPTION OF THE DRAWINGS

FIG. 1 is a two-dimensional schematic diagram of an end face of a single-core microstructure optical fiber designed in an embodiment of the present disclosure, and

in the Figure, a represents a solid capillary rod, b represents a capillary tube, and c represents a glass sleeve of a preform rod.

FIG. 2 is a schematic diagram of an optical fiber preform rod prepared by a stepped stacking type binding method according to an embodiment of the present disclosure.

FIG. 3 is a two-dimensional diagram of an end face of a thin preform rod of the microstructure optical fiber after the first drawing in the present disclosure.

FIG. 4 is a schematic diagram of an optical fiber drawing tower during the second drawing in the present disclosure, and

in the Figure, 1 represents an argon pipe; 2 represents a gas pressure maintaining and adjusting device; 3 represents a gas connector; 4 represents a thin preform rod; 5 represents a fixing device; 6 represents a limiting glass outer sleeve; 7 represents a high-temperature furnace; 8 represents an optical caliper; 9 represents a drawing device; 10 represents a pressure coating device; 11 represents an ultraviolet curing device; and 12 represents a filament winding device.

FIG. 5 is a schematic diagram of the gas pressure maintaining and adjusting device in the present disclosure.

FIG. 6 is a fitting curve of a temperature and a gas pressure during drawing of the single-core microstructure optical fiber of the present disclosure.

FIG. 7 is a fitting curve of a rod feeding speed and a traction speed during drawing of the single-core microstructure optical fiber of the present disclosure.

FIG. 8 is a diagram of an end face of the single-core microstructure optical fiber of the present disclosure, where FIG. 8(a) is the overall end face, and FIG. 8(b) is a partially enlarged end face.

FIG. 9 is a flowchart of a process for preparing a microstructure optical fiber based on two-time drawing and gas pressure control technologies in the present disclosure.

FIG. 10 is a two-dimensional schematic diagram of an end face of a partial double-core microstructure optical fiber in an Embodiment 3 of the present disclosure.

FIG. 11 is a diagram of an end face of the partial double-core microstructure optical fiber in the Embodiment 3 of the present disclosure.

FIG. 12 is a schematic diagram of an end face of a double-core microstructure optical fiber designed in the present disclosure.

FIG. 13 is a two-dimensional schematic diagram of an end face of a thin preform rod of the double-core microstructure optical fiber after the first drawing in the present disclosure.

FIG. 14 is a diagram of an end face of the double-core microstructure optical fiber of the present disclosure, where FIG. 14(a) is the overall end face, and FIG. 14(b) is a partially enlarged end face.

FIG. 15 is a schematic diagram of an end face of a seven-core microstructure optical fiber designed in the present disclosure.

FIG. 16 is a two-dimensional schematic diagram of an end face of the seven-core microstructure optical fiber after the first drawing in the present disclosure.

FIG. 17 is a diagram of an end face of the seven-core microstructure optical fiber of the present disclosure, where FIG. 17(a) is the overall end face, and FIG. 17(b) is a partially enlarged end face.

FIG. 18 is a diagram of an end face of a single-core microstructure optical fiber prepared in a Comparative Example 1.

FIG. 19 is a diagram of an end face of a single-core microstructure optical fiber prepared in a Comparative Example 2.

FIG. 20 is a schematic diagram of an end face of a three-core microstructure optical fiber.

FIG. 21 is a diagram of an end face of the three-core microstructure optical fiber.

### DETAILED DESCRIPTION OF THE EMBODIMENTS

To make the above method and advantages be understood more easily, a gas pressure maintaining and adjusting device, a microstructure optical fiber and a preparation method of the microstructure optical fiber provided by the present disclosure will be described below in detail through embodiments. The applicant has prepared a variety of microstructure optical fibers according to this preparation method. This method can be varied in form and detail, so the present disclosure is by no means limited to the following embodiments.

In the following embodiments, all equipment used is commercially available.

In the following embodiments, before the selected glass tubes and glass rods are used, the outer walls of the glass rods and the inner and outer walls of the glass tubes are scrubbed with high-purity alcohol and dried for later use.

### Embodiment 1

A preparation method of a single-core microstructure optical fiber includes the following steps:

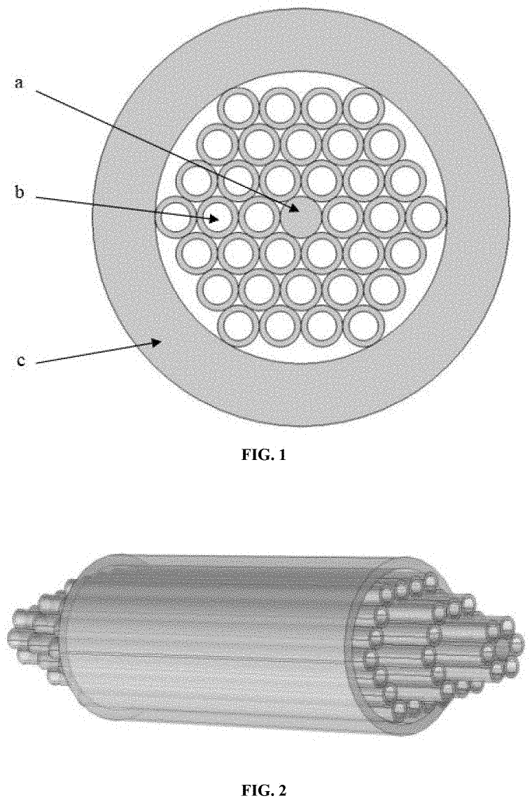

1) the single-core microstructure optical fiber is designed according to a simulation program, and a two-dimensional schematic diagram of an end face of the single-core microstructure optical fiber is shown in FIG. 1. A quartz glass tube with an outer diameter of 20 mm and an inner diameter of 14 mm is selected as a glass sleeve for preparing a preform rod according to a size and a structure of the single-core microstructure optical fiber and is drawn to form a capillary tube with an outer diameter of 2 mm; and meanwhile, a glass rod with a diameter of 20 mm is drawn to form a solid capillary rod with a diameter of 2 mm as a fiber core of the optical fiber.

A preform rod of the single-core microstructure optical fiber with three layers of pores in cladding layers is arranged according to an optical fiber structure shown in FIG. 1 by a stepped stacking type binding method. FIG. 2 is a schematic diagram of a single-core three-layer-pore preform rod obtained after stepped stacking type binding. A gap between an outer edge of a hexagonal structure and the glass sleeve is filled with solid glass capillary rods. In order to increase a utilization rate of the preform rod, a tail end of the preform rod is welded with a glass tube with a length of 250 mm, an inner diameter of 14 mm and an outer diameter of 20 mm as a tail handle by oxyhydrogen flame, and water vapor in the preform rod is removed through a temperature control cabinet after the tail handle is welded.

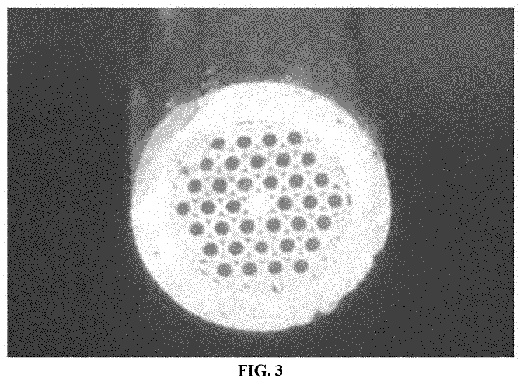

2) The water vapor in the preform rod is removed; the preform rod is fixed to an optical fiber drawing tower through a fixing device and is subjected to the first drawing by sequentially passing through a high-temperature furnace, an optical caliper, a drawing device, a pressure coating device and an ultraviolet curing device to obtain a thin preform rod, where during the second drawing, a glass tube with an outer diameter of 12 mm and an inner diameter of 3.2 mm is used as a limiting glass outer sleeve; therefore, during the first drawing, the optical fiber preform rod with an outer diameter of 20 mm is drawn to form a thin preform rod with an outer diameter of 3.1 mm by adjusting three drawing parameters, namely, a temperature of the high-temperature furnace is adjusted to 1770° C. to 1950° C., a rod feeding speed is adjusted to 1 mm/min to 5 mm/min, and a traction speed is adjusted to 0.5 m/min to 7 m/min. FIG. 3 is a two-dimensional diagram of an end face of the thin preform rod after the first drawing. As shown in FIG. 3, the thin preform rod subjected to the first drawing has a clear and complete structure, the pores in the cladding layers do not collapse and have a uniform size.

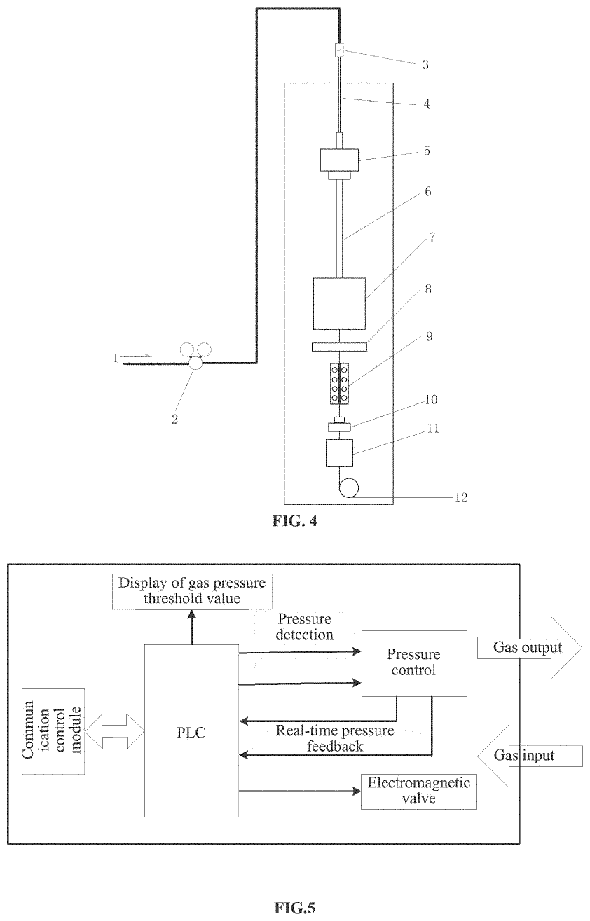

3) After the first drawing, the thin preform rod with an outer diameter of 3.1 mm is inserted into a limiting glass outer sleeve 6 with an inner diameter of 3.2 mm and an outer diameter of 12 mm; the thin preform rod 3 sleeved with the limiting glass outer sleeve is loaded on the optical fiber drawing tower again for the second drawing; the schematic diagram of the optical fiber drawing tower adopted to prepare a microstructure optical fiber in this embodiment is shown in FIG. 4; the optical fiber drawing tower includes an argon pipe 1, a gas pressure maintaining and adjusting device 2 and a fixing device 5, where the argon pipe is connected with argon; the gas pressure maintaining and adjusting device 2 is arranged on the argon pipe 1; the fixing device 5 is arranged on the optical fiber drawing tower; this embodiment is a triangular gripper and further includes a high-temperature furnace 7, an optical caliper 8, a drawing device 9, a pressure coating device 10, an ultraviolet curing device 11 and a filament winding device 12 which are sequentially arranged below the fixing device 5; in addition, the fixing device 5, the high-temperature furnace 7, the optical caliper 8, the drawing device 9, the pressure coating device 10 and the ultraviolet curing device 11 are each provided with a drawing through hole; the drawing through holes are located in the same perpendicular line; and an output end of the argon pipe 1 connected with argon communicates with the a preform rod 4 through a gas connector 3.

As shown in FIG. 4, the triangular gripper on the optical fiber drawing tower is clamped on the limiting glass outer sleeve 6 of a thin preform rod 3. During the second drawing, an initial temperature of the high-temperature furnace is set as 1950° C., and is set as 1800° C. after a material head falls off. After the temperature is lowered to 1800° C. and stable, remnant materials are cut off with sharp-nose iron pliers, the rod feeding speed is set as 4 mm/min, and the traction speed is set as 0.5 m/min. All the fiber filaments initially formed by drawing are solid. Therefore, in order to form the pores in the cladding layers as soon as possible, the temperature of the high-temperature furnace is gradually lowered and the traction speed is appropriately increased. If the optical fiber becomes brittle, cooling needs to be stopped, otherwise the optical fiber may be broken. When the temperature drops to 1775° C. and the traction speed is set as 1.4 m/min, the optical fiber has a diameter of 666 μm; the pores in the optical fiber are almost entirely formed; however, the pores in an inner layer are relatively small, so the thin preform rod is connected with the argon pipe through a two-way gas connector which is internally provided with a metal spring leaf, which is shown in the schematic diagram of the optical fiber drawing tower in FIG. 4

4) In order to prevent collapse of the microstructure pores, argon is injected into the thin preform rod; a flow rate of the argon is adjusted by the gas pressure maintaining and adjusting device 2; the gas pressure maintaining and adjusting device 2 is shown in FIG. 5 and substantially includes a communication control module, a programmable logic controller (PLC), a pressure controller, an electromagnetic valve and a gas pressure threshold display screen. The communication control module is electrically connected with a main console of the optical fiber drawing tower; a signal output end of the communication control module is connected with a signal receiving end of the PLC; the PLC is provided with the gas pressure threshold display screen; the signal receiving end of the PLC is further connected with a signal output end of the pressure controller; and the PLC is further connected with the electromagnetic valve which is used for controlling the opening and closing of a gas inlet and a gas outlet. The communication control module is used for realizing connection and communication between the gas pressure maintaining and adjusting device and the main console of the optical fiber drawing tower; the main console of the optical fiber drawing tower is used for setting a gas pressure threshold of the gas pressure maintaining and adjusting device; and the PCL is used for displaying the gas pressure threshold through the display screen. The pressure controller is used for detecting a pressure in real time, and transmitting the pressure to the PLC; the PLC is used for judging whether the pressure is larger or smaller than the gas pressure threshold so as to transmit signals to control the opening and closing of the electromagnetic valve. If the gas pressure threshold is larger than a gas pressure in an argon discharging pipe, the PLC opens the electromagnetic valve and automatically inflates the argon discharging pipe; if the gas pressure threshold is smaller than the gas pressure in the argon discharging pipe, the PLC opens the electromagnetic valve and automatically exhausts gas from the argon discharging pipe; and if the gas pressure threshold is equal to the gas pressure in the argon discharging pipe, the PLC closes the electromagnetic valve without inflating or exhausting the argon discharging pipe so as to guarantee a constant gas pressure in the thin preform rod.

5) At the beginning, the gas pressure threshold is set as 1 kPa, and the rod feeding speed and the gas pressure threshold are gradually lowered according to the condition of the end face of the optical fiber. When the rod feeding speed is lowered to 2.5 mm/min and the gas pressure threshold is increased to 4 kPa, the pores in the cladding layers of the optical fiber have a basically uniform size. In order to eliminate a crescent gap between the optical fiber and the limiting glass outer sleeve, the gas pressure threshold is gradually increased again; meanwhile, in order to reduce the diameter of the optical fiber and prevent the optical fiber from being broken due to brittleness, the rod feeding speed is lowered again, and the traction speed and the temperature of the high-temperature furnace temperature are gradually increased. When the gas pressure threshold is 8.5 kPa, the temperature of the high-temperature furnace is 1784° C., the rod feeding speed is 1.8 mm/min and the traction speed is 2.8 m/min, the crescent gap disappears completely, the overall pores in the cladding layers become larger and uniform, with a diameter of 329 μm. Since the pores in the cladding layers have been enlarged uniformly and a gas pressure in the pores is high enough to prevent the pores from collapsing, the gas pressure threshold is kept constant in a subsequent process of lowering the size of the optical fiber. After the rod feeding speed is continuously lowered to 1 mm/min, the traction speed is increased to 4.6 m/min and the furnace temperature is gradually increased to 1797° C., the optical fiber has an outer diameter of 190 μm, and the diameter of the fiber cores has been lowered below 10 μm. In order to further lower the fiber core size, the traction speed is continuously increased to 6.4 m/min, and the diameter of the optical fiber is lowered to 160 μm. However, the pores in the cladding layers of the optical fiber become larger and larger due to mutual extrusion and accordingly lose the original uniformity. Therefore, as the diameter of the fiber becomes smaller, the gas pressure threshold should be lowered correspondingly. However, the gas pressure threshold should not be too low, otherwise, a gas pressure in the pores in the cladding layers is not high enough to support the microstructure of the optical fiber and a crescent will be generated again between the microstructure and the limiting glass outer sleeve.

Technological parameters in the second drawing process are analyzed as follows:

FIG. 6 shows a parameter fitting curve of a temperature and a gas pressure threshold of the high-temperature furnace when the microstructure optical fiber is a single-core microstructure optical fiber. At the beginning, a drawing temperature is set as 1800° C., and the furnace temperature is gradually lowered in order to produce pores in the cladding layers as soon as possible. When the furnace temperature is lowered to 1775° C., all pores are basically formed in the cladding layers, and cooling is stopped at the moment. As the diameter of the optical fiber becomes smaller, the optical fiber becomes brittle. In order to prevent the optical fiber from being broken due to excessive brittleness, the furnace temperature is gradually increased. Therefore, in a setting process of temperature parameters of the high-temperature furnace, the temperature has a trend of being lowered first and then increased. Generally, the trend shows a wave trough shape.

A setting process of the gas pressure threshold is just opposite to that of the temperature of the high-temperature furnace. When all the pores appear in the cladding layers of the fiber filament, the gas pressure maintaining and adjusting device is provided. At the beginning, the diameter of the fiber filament is relatively thick. Therefore, the gas pressure is increased in order to prevent collapse of the pores in the cladding layers of the optical fiber in a process of lowering the diameter of the fiber filament. When the diameter of the fiber filament is lowered to a certain extent, the gas pressure threshold should be lowered rather than be increased. When the fiber filament becomes smaller in diameter, the pores in the cladding layers of the optical fiber will be enlarged or even seriously deformed due to blowing if the original gas pressure threshold is maintained. Therefore, in a setting process, the gas pressure threshold has a trend of being increased first and then lowered. Generally, the trend shows a wave peak shape.

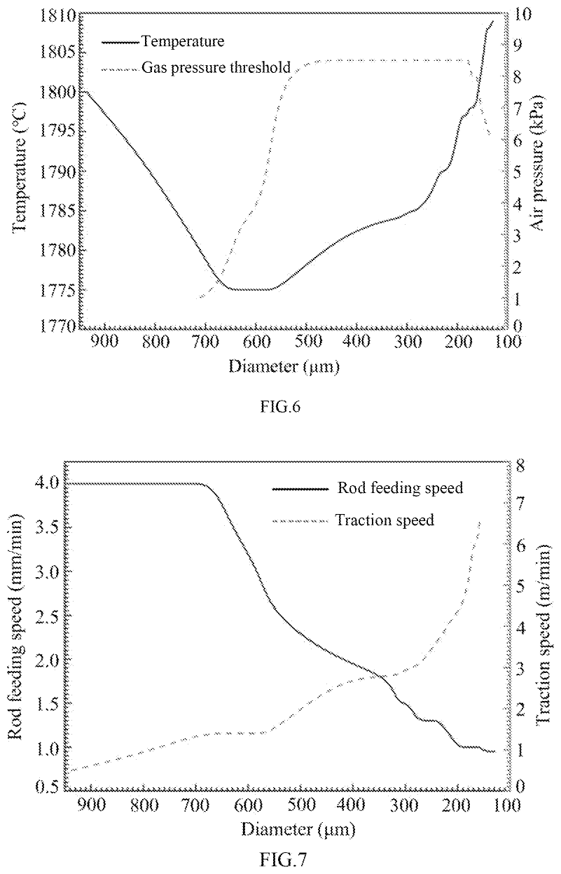

FIG. 7 is a parameter fitting curve of a rod feeding speed and a traction speed. As shown in FIG. 7, the diameter of the optical fiber becomes smaller gradually with decrease of the rod feeding speed. A setting process of the traction speed and the rod feeding speed is just the opposite. The diameter of the optical fiber becomes smaller gradually with increase of traction speed.

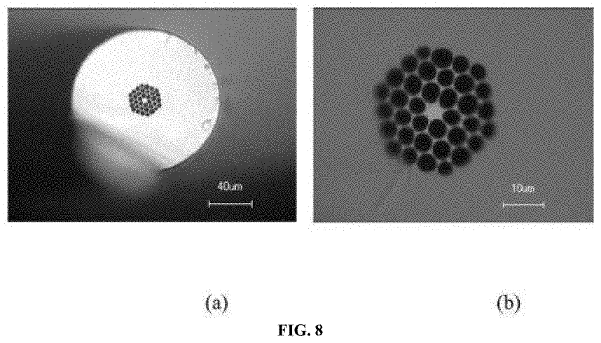

6) After long-time drawing and repeated adjustment of the drawing parameters and when a final temperature is increased to 1809° C., the rod feeding speed is lowered to 0.95 mm/min, the traction speed is increased to 7.7 m/min and the gas pressure threshold is set as 6.1 kPa, the outer diameter and fiber core size of the optical fiber are lowered to 125 μm and 4 μm respectively, the crescent gap disappears and the structure is intact. The end face of the single-core microstructure optical fiber is detected through an optical microscope. The detected end face is shown in FIG. 8, where FIG. 8(a) shows the overall end face, and FIG. 8(b) shows a partially enlarged end face.

### Comparative Example 1

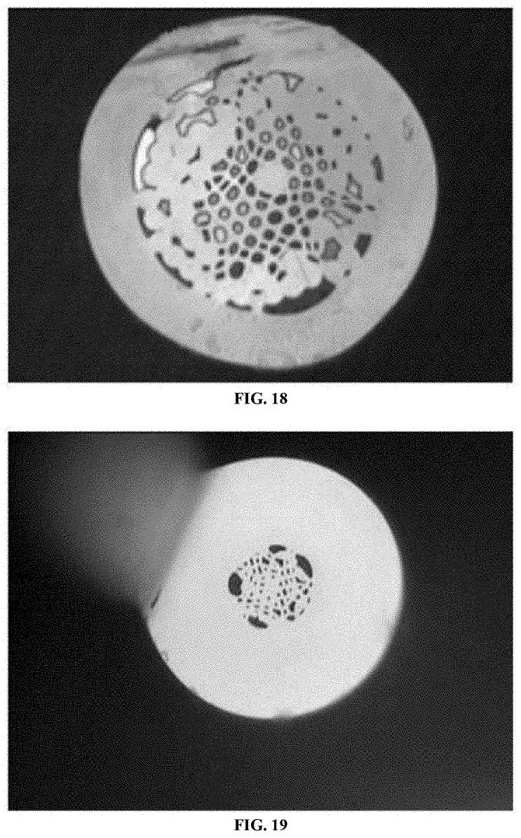

Preparation of a single-core microstructure optical fiber by adopting an optical fiber drawing tower is different from the Embodiment 1 as follows: the optical fiber drawing tower is not provided with a gas pressure maintaining and adjusting device; during the first drawing, the three drawing parameters are adjusted, namely the temperature of the high-temperature furnace is adjusted to 1770° C. to 1950° C., the rod feeding speed is adjusted to 1 mm/min to 5 mm/min and the traction speed is adjusted to 0.5 m/min to 7 m/min; and a schematic diagram of a detected end face of the obtained microstructure optical fiber is shown in FIG. 18.

### Comparative Example 2

Preparation of a single-core microstructure optical fiber by adopting an optical fiber drawing tower is different from the Embodiment 1 as follows: the optical fiber drawing tower is not provided with a gas pressure maintaining and adjusting device; two drawing processes are adopted; the first drawing aims to maintain uniformity and completeness of pore structures in the preform rod and realize formation of the preform rod; and during the second drawing, the thin preform rod is not provided with a glass sleeve, and the second drawing aims to lower the size of the optical fiber. During the two drawing processes, the three drawing parameters are adjusted, namely the temperature of the high-temperature furnace is adjusted to 1770° C. to 1950° C., the rod feeding speed is adjusted to 1 mm/min to 5 mm/min and the traction speed is adjusted to 0.5 m/min to 7 m/min; and a schematic diagram of a detected end face of the obtained microstructure optical fiber is shown in FIG. 19.

The detected end face in FIG. 8 is compared with the detected optical fiber end faces in FIG. 18 and FIG. 19, and results show that this method can effectively solve the problems about collapse and disappearance of the pores in the microstructure optical fiber, and also eliminates the gap between the thin preform rod and the limiting glass outer sleeve.

### Embodiment 2

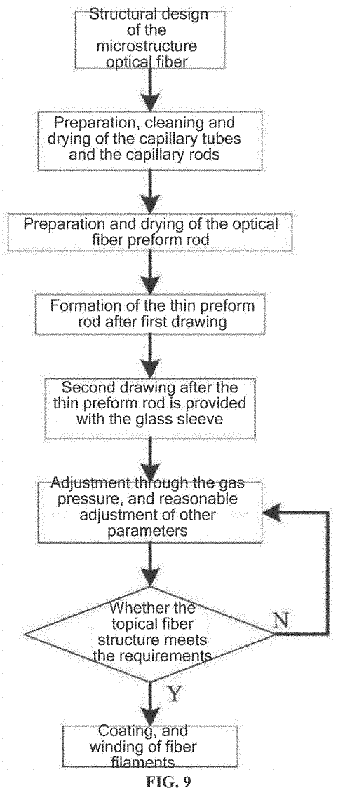

A preparation method of a partial double-core microstructure optical fiber adopts a preparation process shown in FIG. 9 and includes the following specific steps:

1) a partial double-core hexagonal microstructure optical fiber with three layers of pores in cladding layers is designed, as shown in FIG. 10. Solid capillary rods with a diameter of 2 mm and hollow capillary tubes with an outer diameter of 2 mm and an inner diameter of 1.4 mm are formed by drawing, where each optical fiber core is a hollow capillary tube; the periphery of each optical fiber core is provided with three cladding layers; two solid capillary tubes are arranged in the second cladding layer; and one hollow capillary tube is arranged between every two solid capillary tubes.

2) The drawn capillary tubes and capillary rods are stacked and bound by a stepped stacking type binding method to form a hexagonal structure with three layers of pores; a glass sleeve is additionally provided, and a gap between the hexagonal structure and the glass sleeve is filled with solid capillary rods.

3) In order to increase a utilization rate of the preform rod, the preform rod is welded with a tail handle by using oxyhydrogen flame. The preform rod is put into a temperature control cabinet to remove the water vapor in the preform rod.

4) A two-time drawing technology is adopted for drawing; during the first drawing, the temperature of the high-temperature furnace is adjusted to 1770° C. to 1950° C., the rod feeding speed is adjusted to 1 mm/min to 5 mm/min, the traction speed is adjusted to 0.5 m/min to 7 m/min, and a crude preform rod with an outer diameter of 20 mm is drawn to form a thin optical fiber preform rod with an outer diameter of 3.1 mm.

5) A thin preform with an outer diameter of 3.1 mm is inserted into a limiting glass outer sleeve with an inner diameter of 3.2 mm and an outer diameter of 12 mm to undergo the second drawing. During the second drawing, an initial temperature of the high-temperature furnace is set as 1950° C., and the furnace temperature is set as 1800° C. after remnant materials fall off Initial values of the rod feeding speed and the traction speed are set as 4 mm/min and 0.5 m/min, respectively.

6) After all the pores in the optical fiber appear, the thin preform rod is connected with the argon pipe through a two-way gas connector which is internally provided with a metal spring leaf; the gas pressure threshold is adjusted to prevent collapse of the pores in the optical fiber; and at the beginning, the gas pressure threshold is set as 1 kPa and is gradually increased to 3.5 kPa.

7) After the drawing parameters are adjusted repeatedly and when the temperature of the high-temperature furnace is 1759° C., the rod feeding speed is lowered to 1 mm/min, the traction speed is increased to 7.4 m/min and the gas pressure threshold is set as 6.8 kPa, the outer diameter of the optical fiber is as high as 125 μm, and the fiber core size is lowered to 4 μm.

8) The optical fiber reaching the required size is coated and wound.

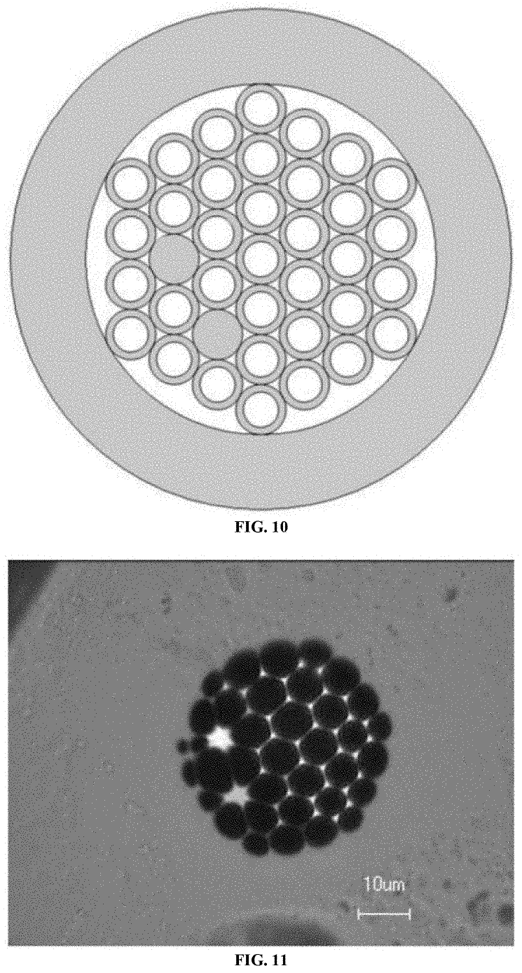

The end face of the prepared partial double-core microstructure optical fiber is observed and is shown in FIG. 11.

### Embodiment 3

A preparation method of a double-core microstructure optical fiber includes the following steps:

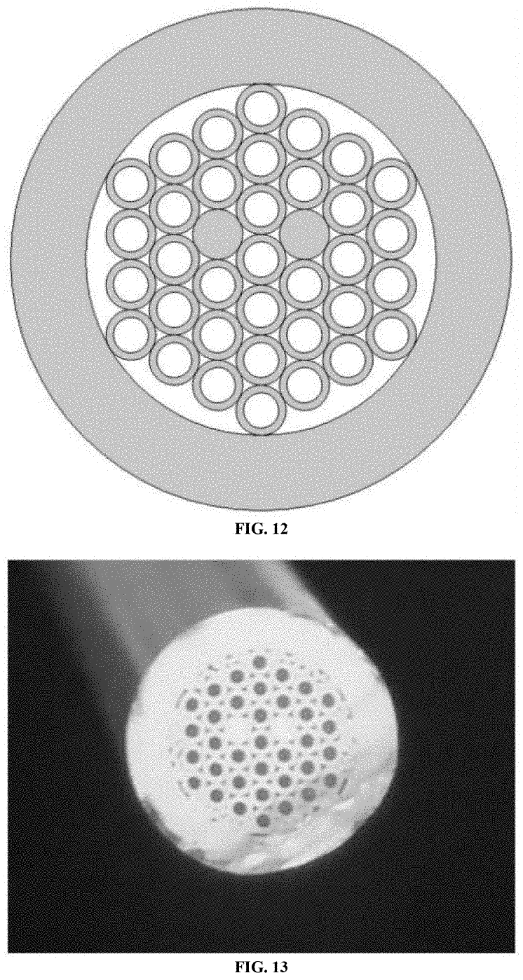

1) quartz glass tubes with an outer diameter of 20 mm and an inner diameter of 14 mm are drawn to form capillary tubes with an outer diameter of 2 mm; the capillary are arranged in three layers by a stepped stacking type binding method; two solid capillary rods with a diameter of 2 mm are used to replace the two capillary tubes in the first cladding layer to form a double-core structure; a center fiber core is replaced with a capillary tube with an outer diameter of 2 mm; and a diagram of an end face of the designed double-core structure is shown in FIG. 12. During the first drawing, three drawing parameters are adjusted, namely a temperature of a high-temperature furnace is adjusted to 1770° C. to 1950° C., a rod feeding speed is adjusted to 1 mm/min to 5 mm/min, and a traction speed is adjusted to 0.5 m/min to 7 m/min; a preform rod with an outer diameter of 20 mm is drawn to form a thin preform rod with an outer diameter of 3.1 mm, and FIG. 13 is a diagram of an end face of the thin preform rod.

2) During the second drawing, the thin preform rod formed by the first drawing is put into a limiting glass outer sleeve with an inner diameter of 3.2 mm; an initial furnace temperature is set as 1950° C., and the temperature of the high-temperature furnace is adjusted to 1800° C. after remnant materials fall off. In the drawing process, the initially drawn optical fibers are all solid, and pores in cladding layers gradually appear by lowering the furnace temperature. When the furnace temperature is lowered to 1743° C., the rod feeding speed is 5 mm/min, and the traction speed is 0.5 m/min, the overall pores in the cladding layers of the microstructure optical fiber appear, and the fiber filament formed by drawing has an outer diameter of 1240 μm. At the moment, a gas discharging pipe of the gas pressure maintaining and adjusting device is connected to a tail end of the thin preform formed after the first drawing, and the gas pressure threshold is gradually increased. After the furnace temperature is increased from 1743° C. to 1772° C., the rod feeding speed is lowered from 5 mm/min to 1 mm/min, the traction speed is increased from 0.5 m/min to 1.5 m/min, and the gas pressure threshold is set as 10 kPa, a gap between a microstructure of the optical fiber and the limiting glass outer sleeve disappears completely, the optical fiber has an outer diameter of 311 μm, and the pores in the cladding layers are basically enlarged uniformly. Since the crescent gap has disappeared and all the pores in the cladding layers become larger, the gas pressure threshold should be lowered slightly rather than be increased again in the subsequent process of lowering the size of the optical fiber. The outer diameter of the optical fiber is lowered to 188 μm after the furnace temperature is continuously increased to 1797° C., the rod feeding speed is lowered to 0.95 mm/min, the traction speed is increased to 4.1 m/min and the gas pressure threshold is lowered to 8.5 kPa.

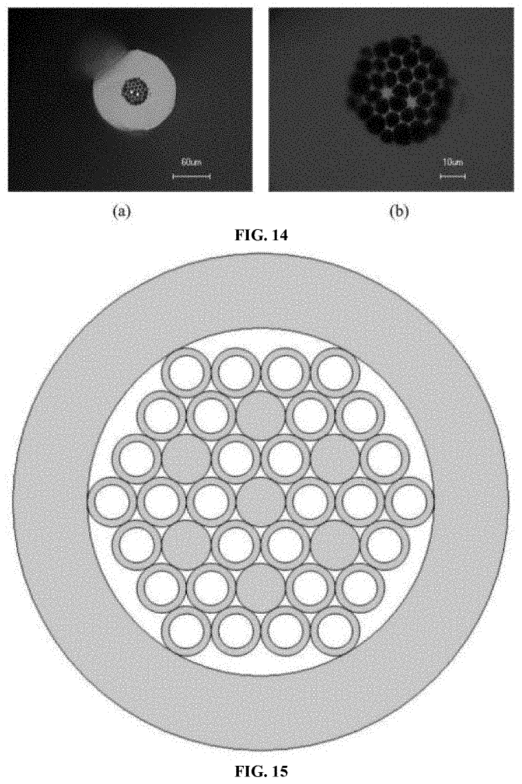

3) After repeated adjustment of the parameters long-time drawing, and when a final temperature of the high-temperature furnace is 1802° C., the rod feeding speed is 0.95 mm/min, the traction speed is increased to 7.4 m/min and the gas pressure threshold is lowered to 8.4 kPa, the fiber core size of the double-core microstructure optical fiber can be lowered below 4 μm. The end face of the double-core microstructure optical fiber is detected by an optical microscope; the detected end face is shown in FIG. 14, where FIG. 14(a) shows the overall end face; and FIG. 14(b) shows a partially enlarged end face.

### Embodiment 4

A preparation method of a seven-core microstructure optical fiber includes the following steps:

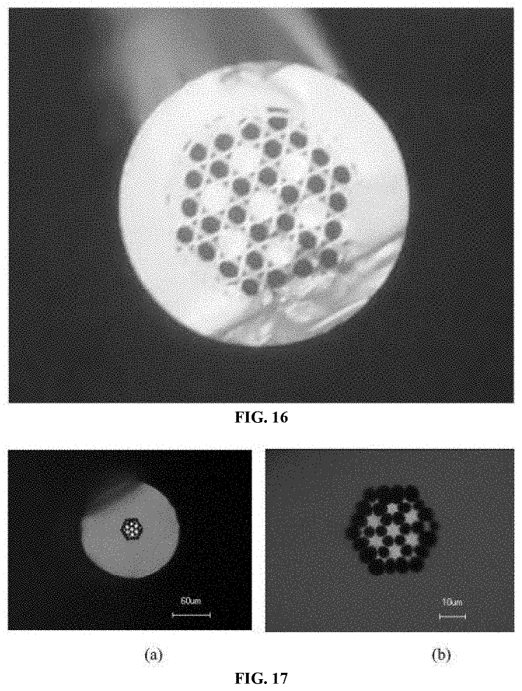

1) According to a preparation method of a preform rod of a seven-core microstructure optical fiber, glass tubes with an outer diameter of 20 mm and an inner diameter of 12 mm are also drawn by a stepped stacking type binding method to form capillary tubes with an outer diameter of 2 mm; afterwards, the capillary tubes are stacked to form a preform rod with a seven-core structure; and a schematic diagram of an end face of the seven-core structure is shown in FIG. 15. After the first drawing, the preform rod with a diameter of 20 mm is drawn to form a thin preform rod with a diameter of 3.1 mm. The preform rod is subjected to the first drawing in order to maintain uniformity and completeness of pore structures in the preform rod and realize formation of the preform rod. FIG. 16 is a two-dimensional diagram of an end face of the thin preform rod formed after the first drawing. As shown in FIG. 16, the pores in the cladding layers in the thin preform rod have a uniform and consistent size and an intact structure.

2) The thin preform rod formed by the first drawing is put into a limiting glass outer sleeve with an outer diameter of 12 mm and an inner diameter of 3.2 mm to undergo the second drawing. An initial furnace temperature is set as 1950° C., and the furnace temperature is adjusted to 1800° C. after remnant materials fall off After the temperature is stable, the remnant materials are cut off with iron pliers; fiber filaments are drown downwards by the drawing device; after the diameter of the fiber filaments is stable, the temperature is gradually lowered; when the furnace temperature is lowered to 1782° C., the rod feeding speed is 3.5 mm/min, the traction speed is 1.2 m/min, and the pores in the cladding layers of the optical fiber appear as a whole. When the rod feeding speed is lowered to 1.3 mm/min and the gas pressure threshold is adjusted to 9.5 kPa, a gap between the optical fiber and the limiting glass outer sleeve is eliminated.

3) After the drawing parameters are adjusted repeatedly and when a final temperature of the high-temperature furnace is 1797° C., the rod feeding speed is 0.93 mm/min and the traction speed is 5.4 m/min, the diameter of the fiber cores is lowered to 4 μm. The end face of the seven-core microstructure optical fiber is detected by an optical microscope; the detected end face is shown in FIG. 17, where FIG. 17(a) shows the overall end face; and FIG. 17(b) shows a partially enlarged end face.

### Embodiment 5

A preparation method of a three-core microstructure optical fiber includes the following steps:

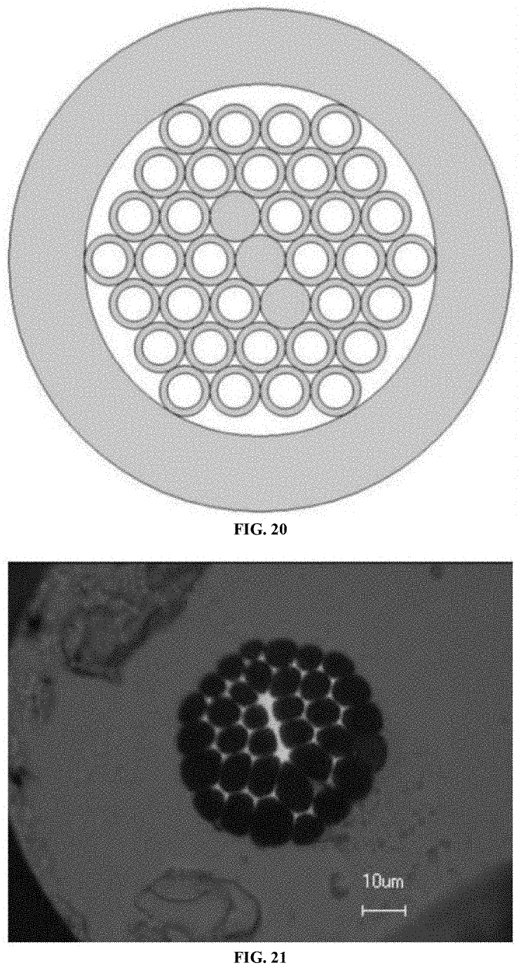

1) the three-core microstructure optical fiber is designed according to a simulation program; a structural schematic diagram of the three-core microstructure optical fiber is shown in FIG. 20; a quartz glass tube with an outer diameter of 20 mm and an inner diameter of 14 mm is selected as a glass sleeve for preparing a preform rod according to a size and a structure of the three-core microstructure optical fiber; the glass tube with an outer diameter of 20 mm and an inner diameter of 14 mm is loaded on a drawing tower and drawn to form a capillary tube with an outer diameter of 2 mm and an inner diameter of 1.4 mm; meanwhile, glass rods with a diameter of 20 mm are loaded on the drawing tower and drawn to form solid capillary rods with a diameter of 2 mm, where the solid capillary rods are used as fiber cores of the optical fiber; and in the first cladding layer, the solid capillary rods are arranged at two positions which are in a mirror-symmetric relationship with the fiber cores of the optical fiber.

2) the glass capillary tubes and capillary rods formed by drawing are screened and cleaned; a preform rod is prepared by a stepped stacking type binding method; firstly, three solid capillary rods and four capillary tubes are stacked and bound together by using a raw material strip according to an arrangement mode shown in FIG. 20, as a first layer in the fiber cores and cladding layers; secondly, 12 capillary tubes which are 1 cm shorter than the first cladding layer are stacked and bound on the outer side of the first layer by using the raw material strip, as a second layer; thirdly, 18 capillary tubes which are 1 cm shorter than the second cladding layer are used as a third layer, and so on; in every two adjacent two layers, there are 6 more capillary tubes in the outer layer than in the inner layer; and the capillary tubes in the outer layer are a little shorter than that in the inner layer. According to the preform rod prepared by the stepped stacking type binding method, geometric centers of circular capillary tubes or circular capillary rods in the same layer are arranged in a hexagonal shape; moreover, after the outermost layer of capillary tube of a hexagonal structure is arranged, the exterior is sleeved with a cylindrical glass sleeve; and a gap between the hexagonal structure and the glass sleeve is filled with thin capillary glass rods with different diameters to form the preform rod.

A tail end of the preform rod is welded with a tail handle with a length of 200 mm to 300 mm with oxyhydrogen flame, and water vapor in the preform rod is removed through a temperature control cabinet. The tail handle has the same outer diameter as the glass sleeve of the preform rod and has an inner diameter which is equal to or a little larger than the inner diameter of the glass sleeve of the preform rod. The water vapor in the preform rod is removed by increasing the temperature above 100° C. in a heating way.

3) The microstructure optical fiber is formed through drawing by a two-time drawing technology; during the first drawing of the preform rod in the first process, the temperature of the high-temperature furnace is adjusted to 1770° C. to 1950° C.; the rod feeding speed is adjusted to 1 mm/min to 5 mm/min; the traction speed is adjusted to 0.5 m/min to 7 m/min; and the preform rod with an outer diameter of 20 mm is drawn to form a thin preform rod with an outer diameter of 3 mm to 5.5 mm. In the first process, the gas pressure maintaining and adjusting device does not need to be started. Afterwards, the thin preform rod is put into the limiting glass outer sleeve and is drawn for the second time, where the inner diameter of the limiting glass outer sleeve is required to be a little larger than the outer diameter of the thin preform rod.

4) According to the method for preparing the microstructure optical fiber through drawing by adopting the two-time drawing technology, when the preform rod is drawn for the second time during the second process, the end face of the preform rod is observed in real time by an optical microscope; when all microstructure pores of the optical fiber are found, the thin preform rod is connected with an argon pipe through a two-way gas connector provided with a metal spring leaf; the gas pressure maintaining and adjusting device is started; and the gas pressure threshold is set to adjust the size of the microstructure pores in the optical fiber according to a condition, observed by the optical microscope, of the microstructure end face of the optical fiber.

5) When the thin preform rod is drawn for the second time in the second process, the outer diameter and the fiber core size of the microstructure optical fiber should be controlled and lowered by adjusting the temperature of the high-temperature furnace, the gas pressure threshold, the rod feeding speed and the traction speed; moreover, a gas pressure in the pores is adjusted by the gas pressure maintaining and adjusting device; and when all parameters are appropriate, and an expected optical fiber microstructure is obtained by drawing, the gas pressure maintaining and adjusting device is used to realize stable pressure maintaining, thereby providing guarantee for batched preparation of microstructure optical fibers.

In this embodiment, the gas pressure maintaining and adjusting device adopted substantially includes a communication control module, a programmable logic controller (PLC), a pressure controller, an electromagnetic valve and a gas pressure threshold display screen. Firstly, the gas pressure maintaining and adjusting device can realize a pressure maintaining function after setting a gas pressure threshold, and is used for maintaining a gas pressure after optical fiber preparation parameters are adjusted stably so as to facilitate batched preparation of high-quality microstructure optical fibers; secondly, the gas pressure maintaining and adjusting device can realize a function of adjusting the gas pressure in a parameter adjustment stage during preparation of the optical fiber; and precise gas pressure adjustment provides an important adjustment means for preparation of microstructure optical fibers with various special structures.

In this embodiment, the communication control module is used to realize connection and communication between the gas pressure maintaining and adjusting device and the main console of the optical fiber drawing tower. The main console of the optical fiber drawing tower is used to set four drawing parameters, including a temperature of the high-temperature furnace, a rod feeding speed, a traction speed and a gas pressure threshold; and after the gas pressure threshold is set, the PLC displays the gas pressure threshold through the display screen. The pressure controller detects a pressure in the argon pipe in real time and transmits the detected pressure to the PLC; and the PLC judges whether the pressure is higher than or lower than a threshold so as to transmit signals to control opening and closing of the electromagnetic valve. If the threshold is higher than a gas pressure in an argon discharging pipe, the PLC opens the electromagnetic valve and automatically inflates the argon discharging pipe; if the threshold is lower than the gas pressure in the argon discharging pipe, the PLC opens the electromagnetic valve and automatically exhausts the argon discharging pipe; and if the threshold is equal to the gas pressure in the argon discharging pipe, the PLC closes the electromagnetic valve without inflating or exhausting the argon discharging pipe, so as to guarantee a constant gas pressure in the preform rod.

6) A gap between the thin preform rod and the limiting glass outer sleeve is eliminated by adjusting the four drawing parameters, namely the temperature of the high-temperature furnace, the gas pressure threshold, the rod feeding speed and the traction speed. The end face of the microstructure optical fiber is observed in real time by an optical microscope; the four drawing parameters are adjusted repeatedly according to the condition of the end face; finally, the outer diameter and the fiber core size of the optical fiber are both lowered to a required size, and a complete microstructure of the optical fiber is maintained; and a diagram of the end face of the obtained three-core microstructure optical fiber is shown in FIG. 21.

1. A gas pressure maintaining and adjusting device, comprising:
a communication control module,
a programmable logic controller (PLC),
a pressure controller,
an electromagnetic valve, and
a gas pressure threshold display screen,
wherein:
the communication control module is electrically connected with a main console of an optical fiber drawing tower;
a signal output end of the communication control module is connected with a signal receiving end of the PLC;
the PLC is provided with the gas pressure threshold display screen;
the signal receiving end of the PLC is further connected with a signal output end of the pressure controller;
the PLC is further connected with the electromagnetic valve used for controlling opening and closing of a gas inlet and a gas outlet;
the communication control module is used for receiving a communication signal instruction of the main console of the optical fiber drawing tower and transmitting the communication signal instruction to the PLC;
the pressure controller is used for detecting a pressure in real time and transmitting the pressure to the PLC; and
the PLC is used for displaying a gas pressure threshold transmitted by a communication module through the gas pressure threshold display screen, and comparing the gas pressure threshold with the pressure detected by the pressure controller, thereby transmitting signals to control opening and closing of the electromagnetic valve.

2. An optical fiber drawing tower, comprising:
an argon pipe,
the gas pressure maintaining and adjusting device according to claim 1,
a fixing device,
a high-temperature furnace,
an optical caliper,
a drawing device,
a pressure coating device,
an ultraviolet curing device, and
a filament winding device,
wherein:
the argon pipe is connected with argon;
the gas pressure maintaining and adjusting device is arranged on the argon pipe;
the fixing device is arranged on the optical fiber drawing tower;
the high-temperature furnace, the optical caliper, the drawing device, the pressure coating device, the ultraviolet curing device and the filament winding device are sequentially arranged below the fixing device;
the high-temperature furnace, the optical caliper, the drawing device, the pressure coating device and the ultraviolet curing device are each provided with a drawing through hole;
the drawing through holes are located in a perpendicular line; and
an output end of the argon pipe connected with argon communicates with a thin preform rod through a gas connector.

3. A preparation method of a microstructure optical fiber, wherein a stepped stacking type binding method is used to prepare a preform rod and adopt a two-time drawing technology to draw the microstructure optical fiber, the preparation method comprising:
during a first drawing process, drawing the preform rod to form a thin preform rod; and
during a second drawing process, sleeving the thin preform rod with a limiting glass outer sleeve;
wherein:
a size of microstructure pores is controlled through a gas pressure; and
four drawing parameters, including a temperature of a high-temperature furnace, a gas pressure threshold, a rod feeding speed and a traction speed, are adjusted for drawing to obtain a microstructure optical fiber.

4. The preparation method of a microstructure optical fiber according to claim 3, further comprising:
step 1, preparation of a preform rod:
designing a microstructure optical fiber according to a simulation program;
selecting glass tubes and glass rods according to a size and a structure of the microstructure optical fiber;
drawing the glass tubes and the glass rods to form capillary tubes and capillary rods;
preparing a preform rod by adopting a stepped stacking type binding method; and
removing water vapor in the preform rod;
step 2, two-time drawing:
conducting the first drawing process on the preform rod from which the water vapor is removed to obtain a thin preform rod, wherein the thin preform rod has an outer diameter of 3 mm to 5.5 mm;
sleeving a periphery of the thin preform rod with a limiting glass outer sleeve;
conducting the second drawing process;
observing an end face of the thin preform rod in real time by an optical microscope in the second drawing process;
when all microstructure pores of the optical fiber are found, connecting the thin preform rod with an argon pipe connected with argon and starting the gas pressure maintaining and adjusting device;
setting a gas pressure threshold according to a condition, observed by the optical microscope, of the microstructure end face of the optical fiber; and
controlling a size of the microstructure pores in the optical fiber; and
step 3, adjustment:
adjusting a temperature of the high-temperature furnace to 1743° C. to 1950° C., a gas pressure threshold to 1 kPa to 10 kPa, a rod feeding speed to 0.93 mm/min to 5 mm/min, and a traction speed to 0.5 m/min to 7.7 m/min;
eliminating a gap between the thin preform rod and the limiting glass outer sleeve; observing an end face of the microstructure optical fiber in real time by an optical microscope;
repeatedly adjusting the drawing parameters according to the condition of the end face;
simultaneously controlling a gas pressure in the microstructure pores by the gas pressure maintaining and adjusting device, so as to control and lower an outer diameter and a fiber core size of the microstructure optical fiber to finally obtain a microstructure optical fiber with a complete structure.

5. The preparation method of a microstructure optical fiber according to claim 4, wherein the stepped stacking type binding method is as follows:
a center fiber core and a plurality of cladding layers are arranged according to a number of fiber cores and the number and structure of the cladding layers in the microstructure optical fiber, wherein a first cladding layer is as long as the center fiber core, a second cladding layer is 1 cm to 2 cm shorter than the first cladding layer, and a length of each of the other cladding layers is determined in this manner until an overall fiber cores and the cladding layers are formed to form a hexagonal structure;
the hexagonal structure is sleeved with a glass sleeve; a space between the hexagonal structure and the glass sleeve is filled with a solid thin capillary rod to form a preform rod, wherein the center fiber core adopts a capillary rod or a capillary tube; and
capillary tubes or capillary tubes and capillary rods are used as the cladding layers according to the number and arrangement of the fiber cores of the microstructure optical fiber.

6. The preparation method of a microstructure optical fiber according to claim 4, wherein in the step 1, each capillary rod has a diameter of 0.8 cm to 2.2 cm, the capillary tubes have the same diameter as the capillary rods, and each capillary tube has an inner diameter of 0.3 mm to 1.8 mm.

7. The preparation method of a microstructure optical fiber according to claim 4, wherein in the step 1:
one end of the preform rod is welded with a glass tube with a length of 200 mm to 300 mm as a tail handle;
the preform rod is placed in a temperature control cabinet at 100° C. to 200° C. to remove water vapor in the preform rod; and
the tail handle has the same outer diameter as the glass sleeve of the preform rod, and has an inner diameter larger than or equal to the inner diameter of the glass sleeve of the preform rod.

8. The preparation method of a microstructure optical fiber according to claim 4, wherein in the step 2, the first drawing process is conducted by adjusting the three drawing parameters, namely a temperature of the high-temperature furnace is adjusted to 1770° C. to 1950° C., a rod feeding speed is adjusted to 1 mm/min to 5 mm/min, and a traction speed is adjusted to 0.5 m/min to 7 m/min.

9. The preparation method of a microstructure optical fiber according to claim 3, wherein the microstructure pores in cladding layers of the microstructure optical fiber are arranged in a hexagonal shape as a whole, quartz is used as a base material, and fiber cores have a diameter of 3 μm to 10 μm.

10. The preparation method of a microstructure optical fiber according to claim 9, wherein the fiber cores in the microstructure optical fiber adopt a total internal reflection type transmission mode.
